(19) United States
(12) Patent Application Publication
(10) Pub. No.: US 2022/0128192 A1
(43) Pub. Date: Apr. 28, 2022

(54) TABLET PERSONAL COMPUTER BRACKET WITH FLEXIBLE FOUNDATION

(71) Applicant: Shenzhen Xgear Technology Co., Ltd., Shenzhen (CN)

(72) Inventor: Jie Wang, Shenzhen (CN)

(21) Appl. No.: 17/483,915

(22) Filed: Sep. 24, 2021

(30) Foreign Application Priority Data
Oct. 23, 2020 (CN) 202022387797.9

(51) Int. Cl. F16M 11/22; F16M 11/04; F16M 11/10

(52) U.S. Cl. CPC F16M 11/22; F16M 2200/08; F16M 11/10; F16M 11/041

(57) ABSTRACT

The invention relates to a tablet personal computer bracket with a flexible foundation, comprises the flexible foundation and a support frame, the flexible foundation is a cloth bag filled with a flexible body; the support frame is comprised of a flat support frame base and a support component; the flat support frame base is fixedly connected to a top surface of the flexible foundation; the support component is connected to the flat support frame base; the support component comprises a fixed component and a movable component; the fixed component is fixedly connected to the flat support frame base; the movable component is rotatably connected with the fixed component. The invention can be used on an uneven surface. A whole bottom can be in contact with a load-bearing surface and the whole tablet personal computer bracket with a flexible foundation can be firmly erected on the load-bearing surface.

### CROSS REFERENCE TO RELATED APPLICATIONS

The present application claims the benefit of Chinese Patent Application No. 202022387797.9 filed on Oct. 23, 2020, the contents of which are incorporated herein by reference in their entirety.

### FIELD OF INVENTION

The invention relates to a peripheral auxiliary product of a tablet personal computer, in particular to a tablet personal computer bracket with a flexible foundation.

### BACKGROUND ART OF THE INVENTION

The development of electronic products in the present society is changing with each passing day. Mobile phones and tablet personal computers, in particular, are increasingly replacing traditional desktop computers, bearing the main functions of work and entertainment. Because of the portability of mobile phones and tablet personal computers, people like to carry them around for use. After using mobile phones and tablet personal computers for a long time, a person may feel his/her hands tired, and cannot change posture for a long time, so his/her cervical spine and shoulders may ache, affecting the use experience. Therefore, brackets for mobile phones and tablet personal computers are invented. Each of current mobile phone or tablet personal computer brackets is comprised of a base, a connecting piece and a clip, wherein the base is usually a counterweight disc or clamping piece configured to fix the bracket on a table top, the clip is configured to clamp a mobile phone or tablet personal computer, and the connecting piece is connected to the base and the clip. For an existing mobile phone or tablet personal computer bracket, if a base thereof is a counterweight disc, the bracket is placed on a flat upper table or ground for use, and if the base is a clip, the bracket is clamped on a table board or other similar thin board for fixing. The bracket is unable to be placed stably when used on a soft surface such as a leg, sofa or mattress, being unable to use. Modern people spend more and more time on the sofa or bed when using their mobile phones or tablet personal computers for entertainment and work. Therefore, there is an urgent need to design a mobile phone or tablet personal computer bracket which can be used on a soft load-bearing surface to expand the use occasions and improve the use experience.

### DISCLOSURE OF THE INVENTION

The purpose of the invention is to overcome the above disadvantages and defects in the prior art, and provide a novel tablet personal computer bracket with a flexible foundation. The invention is used for placing a mobile phone or tablet personal computer, is convenient for people to use the mobile phone and tablet personal computer, and especially to place a mobile phone or tablet personal computer bracket with a flexible foundation on a soft sofa cushion and a mattress or an uneven place for use.

The purpose of the invention is realized by the following technical solution:

A tablet personal computer bracket with a flexible foundation, comprising: the flexible foundation and a support frame, characterized in that: the flexible foundation is a cloth bag filled with a flexible body; a cloth used for the cloth bag is an elastic cloth; the support frame is comprised of a flat support frame base and a support component; the flat support frame base is fixedly connected to a top surface of the flexible foundation; the support component is connected to the flat support frame base; the support component comprises a fixed component and a movable component; the fixed component is fixedly connected to the flat support frame base; the movable component is rotatably connected with the fixed component; the movable component is also provided with a support plate; and the support plate is rotatably connected with the movable component. In this way, as the flexible foundation is the cloth bag filled with the flexible body, and a cloth used for the cloth bag is an elastic cloth, when the flexible foundation is placed on legs or placed on an uneven surface, the flexible body can be shaped, can be automatically leveled by slightly pressing so that the whole bottom can be in close contact with a load-bearing surface and the whole tablet personal computer bracket with a flexible foundation can be firmly erected on the load-bearing surface for convenient use. As the cloth bag is made of the elastic cloth, when moving, the flexible body can withstand certain deformation, and the cloth bag is more convenient to rapidly adapt to an appropriate position during use. The support frame is comprised of the flat support frame base and the support component; the flat support frame base is fixedly connected to the top surface of the flexible foundation; the support component is connected to the flat support frame base; the support component comprises the fixed component and the movable component; the fixed component is fixedly connected to the flat support frame base; the movable component is rotatably connected with the fixed component; the movable component is also provided with the support plate; and the support plate is rotatably connected with the movable component. The support plate can be another plate rotatably connected to the movable component, and can also be connected in a space hallowed in the middle of the movable component. Through the rotation of the movable component and the support plate, the fixed component, the movable component and the support plate form a triangle, which forms a stable support for a tablet personal computer and is very convenient to use.

Another preferred solution of the invention is: the flexible body comprises one or more of foam particles, spongy bodies, PVC particles, PE particles and Semen Cassiae. These particles have a certain fluidity, are easy to level, have a comfortable hand feeling, and can provide a good use experience.

Another preferred solution of the invention is: a bottom of the cloth bag is also provided with silica gel particles. The bottom is provided with the silica gel particles, and the silica gel particles increase a frictional force between the bottom of the cloth bag and a support surface, preventing sliding when the bracket is used on table top and the legs, being stable in use. Moreover, when the bracket is used on human legs, the silica gel particles can separate a bottom of the cloth bag and a human body by a certain gap, being conducive to air circulation and avoiding heat accumulation; and when the bracket is used for a long time, the human legs are not too hot, overcoming the problem of comfortlessness due to heat accumulation on the legs when the bracket is used for a long time.

Another preferred solution of the invention is: a magnetic substance is provided inside the movable component, and a substance capable of attracting the magnetic substance is provided in the flat support frame base in a position corresponding to the movable component.

Another preferred solution of the invention is: a magnetic substance is provided inside the flat support frame base in a position corresponding to the movable component, and a substance capable of attracting the magnetic substance is provided in the movable component in a relative position.

The attractive substances are provided in the movable component or the base in relative positions. When the bracket is not used at ordinary times, the movable component and the base can be attracted together with good integrity.

Another preferred solution of the invention is: the flat support frame base is provided with a plurality of horizontal convex strips which are parallel. The plurality of horizontal convex strips which are parallel are used to limit the support plate. By using the horizontal convex strips, a support position of the support plate can be adjusted so that a slope angle of the movable component can be changed accordingly to adapt to various application needs.

In the invention, when the tablet personal computer bracket is unfolded, the tablet personal computer is placed on the bracket for use, and the bracket can also be used as a throw pillow. When being folded, the bracket may be used as the throw pillow or a table board, which is very convenient and is good in use experience.

### DESCRIPTION OF DRAWINGS

FIG. 1 is a structural schematic diagram of a tablet personal computer bracket with a flexible foundation in a folding state in embodiment 1 of the invention.

FIG. 2 is a structural schematic diagram of a tablet personal computer bracket with a flexible foundation in a stretching state in embodiment 1 of the invention.

### DETAILED DESCRIPTION OF THE INVENTION

Some preferred embodiments of the invention are provided below in order to further understand the invention.

### Embodiment 1

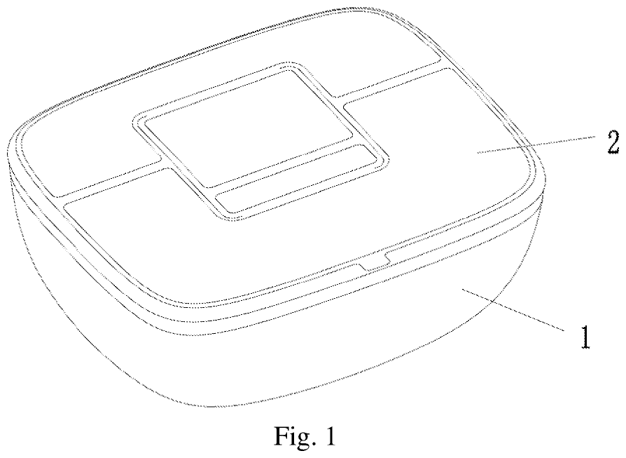

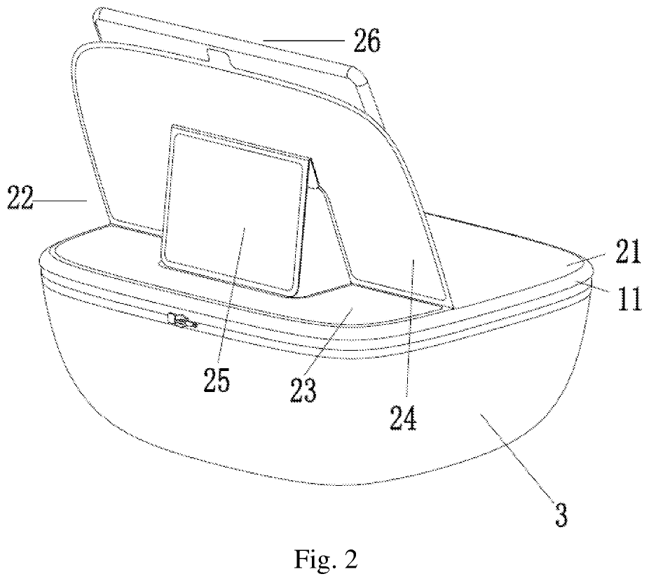

FIG. 1 is a structural schematic diagram of a tablet personal computer bracket with a flexible foundation in a folding state in embodiment 1 of the invention. FIG. 2 is a structural schematic diagram of a tablet personal computer bracket with a flexible foundation in a stretching state in embodiment 1 of the invention. As shown in FIG. 1 and FIG. 2, a tablet personal computer bracket with a flexible foundation comprises the flexible foundation 1 and a support frame 2. The flexible foundation is a cloth bag 3 filled with a flexible body; a cloth used for the cloth bag is an elastic cloth; the support frame is comprised of a flat support frame base 21 and a support component 22; the flat support frame base is fixedly connected to a top surface 11 of the flexible foundation; the support component is connected to the flat support frame base; the support component comprises a fixed component 23 and a movable component 24; the fixed component is fixedly connected to the flat support frame base; the movable component is rotatably connected with the fixed component; the movable component is also provided with a support plate 25; and the support plate is rotatably connected with the movable component. When the tablet personal computer bracket is opened, the support plate is supported between the fixed component and the movable component to form a triangular support frame, and the tablet personal computer 26 is placed on the flat support frame base with a back against the movable component. A shape of the support component is adapted to a shape of the flat support frame base. When the support component is retracted, the support component can be folded on the flat support frame base.

The used flexible body is Semen Cassiae, and as an alternative solution, foam particles, PVC particles, spongy bodies, and the like can also be used.

A bottom of the cloth bag can also be provided with silica gel particles.

A magnetic substance can also be provided inside the movable component, and a substance capable of attracting the magnetic substance is provided in the flat support frame base in a position corresponding to the movable component.

As an alternative solution, a magnetic substance is provided inside the flat support frame base in a position corresponding to the movable component, and a substance capable of attracting the magnetic substance is provided in the movable component in a relative position.

Further, the flat support frame base is provided with a plurality of horizontal convex strips which are parallel.

The above embodiment is a preferred implementation mode of the invention. However, the implementation mode of the invention is not limited by the above embodiment. Any other change, modification, replacement, combination and simplification made without departing from the spiritual essence and principle of the invention shall be equivalent substitution mode, and shall be included within the protection scope of the invention.

What is claimed is:

1. A tablet personal computer bracket with a flexible foundation, comprising: the flexible foundation and a support frame, characterized in that: the flexible foundation is a cloth bag filled with a flexible body; a cloth used for the cloth bag is an elastic cloth; the support frame is comprised of a flat support frame base and a support component; the flat support frame base is fixedly connected to a top surface of the flexible foundation; the support component is connected to the flat support frame base; the support component comprises a fixed component and a movable component; the fixed component is fixedly connected to the flat support frame base; the movable component is rotatably connected with the fixed component; the movable component is also provided with a support plate; and the support plate is rotatably connected with the movable component.

2. The tablet personal computer bracket with a flexible foundation according to claim 1, characterized in that: the flexible body comprises one or more of foam particles, spongy bodies, PVC particles, PE particles and Semen Cassiae.

3. The tablet personal computer bracket with a flexible foundation according to claim 1, characterized in that: the bottom of the cloth bag is also provided with silica gel particles.

4. The tablet personal computer bracket with a flexible foundation according to claim 1, characterized in that: a magnetic substance is provided inside the movable component, and a substance capable of attracting the magnetic substance is provided in the flat support frame base in a position corresponding to the movable component.

5. The tablet personal computer bracket with a flexible foundation according to claim 1, characterized in that: a magnetic substance is provided inside the flat support frame base in a position corresponding to the movable component, and a substance capable of attracting the magnetic substance is provided in the movable component in a relative position.

6. The tablet personal computer bracket with a flexible foundation according to claim 1, characterized in that: the flat support frame base is provided with a plurality of horizontal convex strips which are parallel.
